(19) United States
(12) Patent Application Publication
(10) Pub. No.: US 2002/0003559 A1
(43) Pub. Date: Jan. 10, 2002

(54) Head chip and head unit

(76) Inventor: Toshihiko Harajiri, Chiba-shi (JP)

Correspondence Address: ADAMS & WILKS, 31st Floor, 50 Broadway, New York, NY, 10004, US

(21) Appl. No.: 09/864,960

(22) Filed: May 24, 2001

(30) Foreign Application Priority Data
May 31, 2000 (JP) 2000-163267

(51) Int. Cl. B41J 2/045

(52) U.S. Cl. 347/68

(57) ABSTRACT

A head chip and a head unit, in which recording density is improved and also manufacturing cost is reduced, are provided, in a head chip in which: partition walls 12 made of piezoelectric ceramic are arranged on a board 11 with predetermined intervals; chambers 13 are defined between the respective partition walls 12; a driver voltage is applied to electrodes 14 provided on the side surfaces of the partition walls 12 to change the capacity in the chambers 13; and the ink filled in the chambers 13 is jetted from nozzle openings, the chambers 13 are arranged in parallel between two upper and lower sheets of boards 11a and 11b, which are made of a dielectric material having a light transmitting property, in the width direction with predetermined intervals, and also a plurality of the boards are laminated in the vertical direction.

### BACKGROUND OF THE INVENTION

1. Field of the Invention

The present invention relates to a head chip that is mounted on an ink-jet type recording apparatus applicable to, for example, a printer and a facsimile, and a head unit using the head chip.

2. Description of the Related Art

Conventionally, an ink-jet type recording apparatus is known in the technical field, in which a recording head for jetting ink droplets from a plurality of nozzles is employed to record characters and/or images on a recording medium. In such an ink-jet type recording apparatus, the recording head positioned opposite to the recording medium is provided on a head holder, and the head holder is mounted on a carriage so as to be scanned along a direction perpendicular to a transport direction of the recording medium.

In FIG. 14, there is shown an exploded/perspective view of one example of such a recording head. FIGS. 15A and 15B are sectional view of a major portion of this recording head. FIG. 15A is a sectional view of the recording head taken along the longitudinal direction of side walls. FIG. 15B is a sectional view of the recording head taken along the thickness direction of side walls. As shown in FIG. 14 and FIG. 15, a plurality of grooves 102 are arranged in a piezoelectric ceramic plate 101 in a parallel manner. The respective grooves 102 are separated from each other by side walls 103. One end portion of each of the grooves 102 in the longitudinal direction is elongated up to one end surface of the piezoelectric ceramic plate 101, whereas the other end portion is not elongated up to the other end surface of this piezoelectric ceramic plate, and a depth thereof gradually becomes shallow. Also, an electrode 105 for applying a driving electric field is formed on surfaces of both the side walls 103 on the opening side within each of the grooves 102 along the longitudinal direction.

A cover plate 107 is jointed via an adhesive agent 109 to the grooves 102 of the piezoelectric ceramic plate 101 on the opening side. This cover plate 107 has an ink chamber 111 that constitutes a concave portion which is communicated to the shallow other end portion of each of the grooves 102 and an ink supply port 112 that is penetrated through a bottom portion of this ink chamber 111 along a direction opposite to the direction of the grooves 102.

A nozzle plate 115 is jointed on an end surface of a joint member made by the piezoelectric ceramic plate 101 and the cover plate 107, at which the grooves 102 are opened. Nozzle openings 117 are formed in the nozzle plate 115 at such positions located opposite to the respective grooves 102.

It should be noted that a wiring board 120 is fixed on such a surface of the piezoelectric ceramic plate 101, which is located opposite to the nozzle plate 115 and also opposite to the cover plate 107. A wiring line 122 which is electrically connected to each of the electrodes 105 by employing a bonding wire 121 or the like is formed on the wiring board 120. A driver voltage may be applied via this wiring line 122 to the electrode 105.

In the recording head constituted as described above, when ink is filled from the ink supply port 112 into the respective grooves 102 and a predetermined driving electric field is applied via the electrode 105 to the side walls 103 on both sides of a predetermined groove 102, the side walls 103 are deformed, so that a capacity formed with in this predetermined groove 102 is changed. As a result, the ink filled in the grooves 102 may be jetted from the nozzle opening 117.

For example, as shown in FIG. 16, in the case where ink is jetted from a nozzle opening 117 corresponding to a groove 102a, a positive driving voltage is applied to both electrodes 105a and 105b provided in the groove 102a, and also electrodes 105c and 105dlocated opposite to these electrodes 105a and 105b are grounded. As a consequence, a driving electric field directed to the groove 102a is effected to the side walls 103a and 103b. When this driving electric field is positioned perpendicular to the polarization direction of the piezoelectric ceramic plate 101, both the side walls 103a and 103b are deformed along the direction of the groove 102a due to the piezoelectric thickness slip effect, so that the capacity defined in the groove 102a is reduced to thereby increase pressure. Thus, the ink may be jetted from the nozzle opening 117.

Further, such a head chip is mounted on an ink jet type recording apparatus, and this has widely spread as a color printer by using color ink. Along with this, it is required that printing quality and recording density are improved.

However, in the case where grooves are arranged with high density for improving the printing quality and the recording density, there is a problem in that the thickness of the side walls between the respective grooves becomes thinner, and thus rigidity of the side walls is insufficient, thereby causing generation of crosstalk between respective chambers.

### SUMMARY OF THE INVENTION

The present invention has been made in view of the above, and an object of the present invention is to provide a head chip and a head unit in which recording density is improved and also manufacturing cost is reduced.

In order to solve the above problems, according to a first aspect of the present invention, there is provided a head chip in which: partition walls made of piezoelectric ceramic are arranged on a board with predetermined intervals; chambers are defined between the respective partition walls; a driver voltage is applied to electrodes provided on the side surfaces of the partition walls to change the capacity in the chambers; and the ink filled in the chambers is jetted from nozzle openings, characterized in that the chambers are arranged between two upper and lower sheets of boards, which are made of a dielectric material having a light transmitting property, in the width direction with predetermined intervals, and also a plurality of the boards are laminated in the vertical direction.

According to a second aspect of the present invention, in the first aspect of the present invention, there is provided a head chip characterized in that a plurality of units, in which the partition walls are arranged between two boards with predetermined intervals, are laminated.

According to a third aspect of the present invention, in the first aspect of the present invention, there is provided a head chip characterized in that the partition walls are arranged on both surfaces of a board with predetermined intervals.

According to a fourth aspect of the present invention, in the first aspect of the present invention, there is provided a head chip, characterized in that:

a nozzle plate having the nozzle openings that communicate with the chambers is provided at end surfaces of the partition walls in the longitudinal direction; and

ink chambers that communicate with the respective chambers, are provided on the side of the other end portions of the partition walls.

According to a fifth aspect of the present invention, in the fourth aspect of the present invention, there is provided a head chip characterized in that the nozzle plate is formed of a dielectric material.

According to a sixth aspect of the present invention, there is provided a head unit characterized in that the head unit comprises the head chip as claimed in any one of claims 1 to 5 and a head holder that mounts the head chip.

According to a seventh aspect of the present invention, in the sixth aspect of the present invention, there is provided a head unit characterized in that the head holder may detachably hold an ink cartridge in which ink is stored.

According to the present invention, alignment of chambers when arranging in parallel the chambers on both surfaces of the board can be easily performed by using the board formed from a transparent dielectric material, and thus recording density can be improved.

### BRIEF DESCRIPTION OF THE DRAWINGS

In the accompanying drawings:

FIG. 1 is a perspective view showing a head chip according to Embodiment 1 of the present invention;

FIG. 2 is a sectional perspective view indicating the head chip according to Embodiment 1 of the present invention;

FIG. 3 is a sectional view representing the head chip according to Embodiment 1 of the present invention, taken along a parallel-arranging direction of a chamber;

FIG. 4 is a sectional view taken along a line A-A′ of FIG. 3 according to Embodiment 1 of the present invention;

FIG. 5 is a top view showing a manufacturing method of the head chip according to Embodiment 1 of the present invention;

FIG. 6 is a sectional view representing the head chip corresponding to the respective manufacturing steps of FIG. 5 along the parallel-arranging direction of the chamber;

FIG. 7 is a top view showing a manufacturing method of the head chip according to the embodiment of the present invention;

FIG. 8 is a sectional view representing the head chip corresponding to the respective manufacturing steps of FIG. 7 along the parallel-arranging direction of the chamber;

FIG. 9 is a perspective view indicating an assembly of a unit with employment of the head chip according to Embodiment 1 of the present invention;

FIG. 10 is a perspective view indicating an assembly of a unit with employment of the head chip according to Embodiment 1 of the present invention;

FIG. 11 is a sectional view representing a head chip according to Embodiment 2 of the present invention, taken along a parallel-arranging direction of a chamber;

FIG. 12 is a sectional view taken along a line A-A′ of FIG. 3 according to Embodiment 2 of the present invention;

FIG. 13 is a perspective view showing a use mode of a unit employing a head chip according to other embodiment of the present invention;

FIG. 14 is an exploded perspective view schematically showing a recording,head in accordance with a conventional technique;

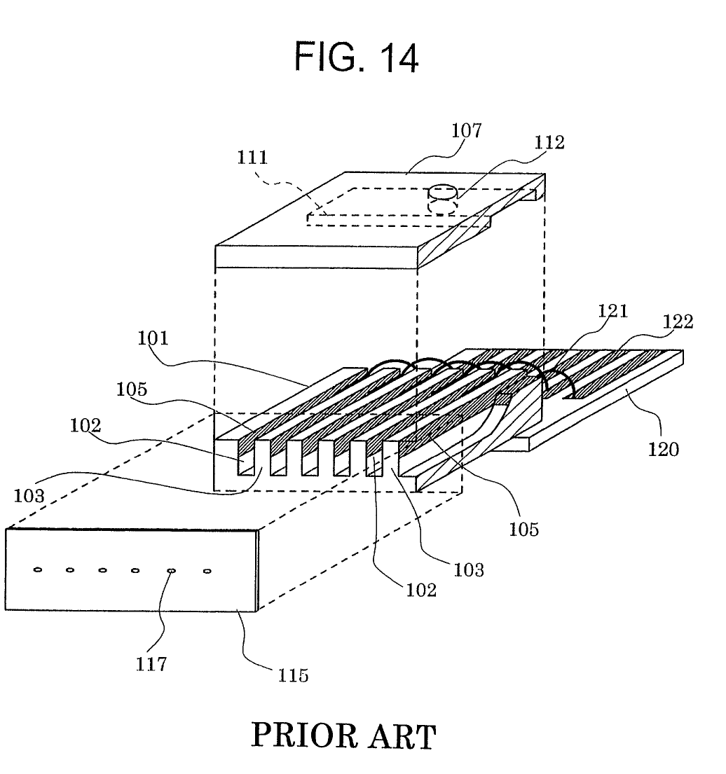

FIG. 15 is a sectional view schematically indicating the recording head in accordance with the conventional technique; and

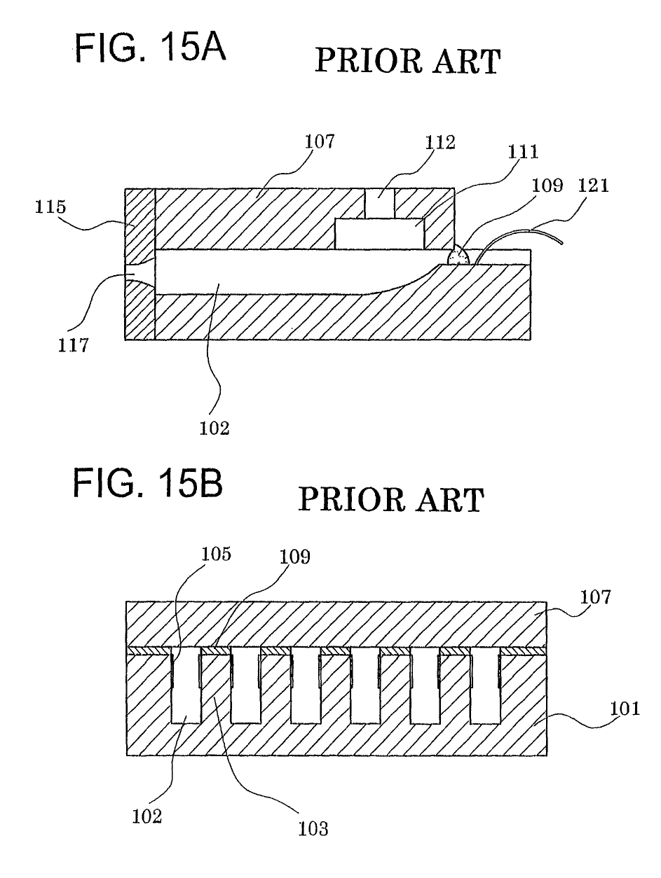

FIG. 16 is a sectional view schematically indicating the recording head in accordance with the conventional technique.

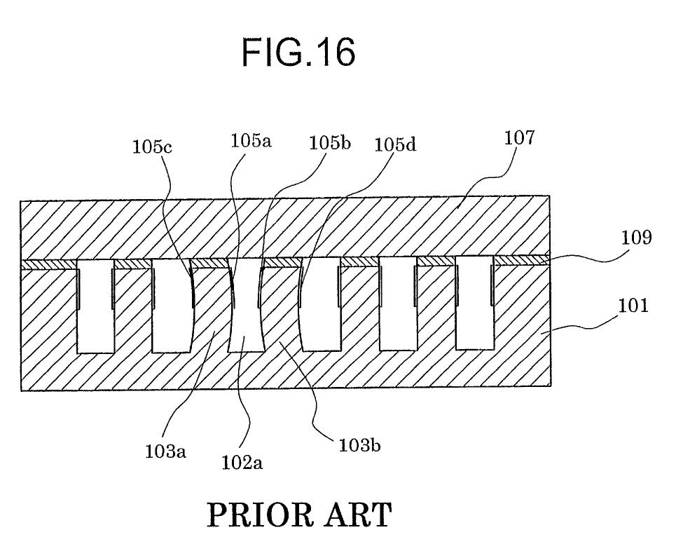

### DETAILED DESCRIPTION OF THE PREFERRED EMBODIMENTS

Hereinafter, the present invention will be explained in detail with reference to embodiments.

### Embodiment 1

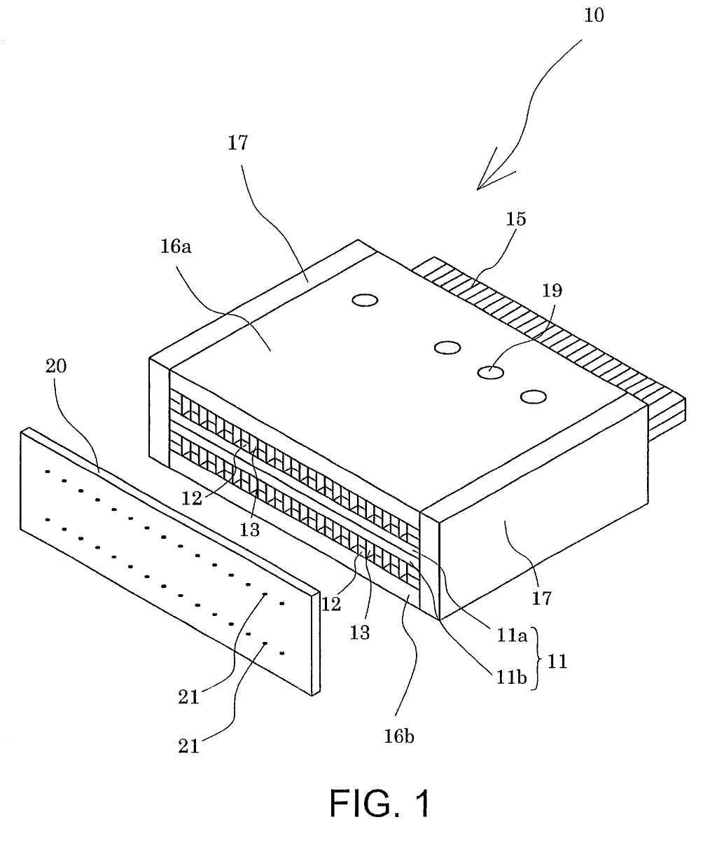

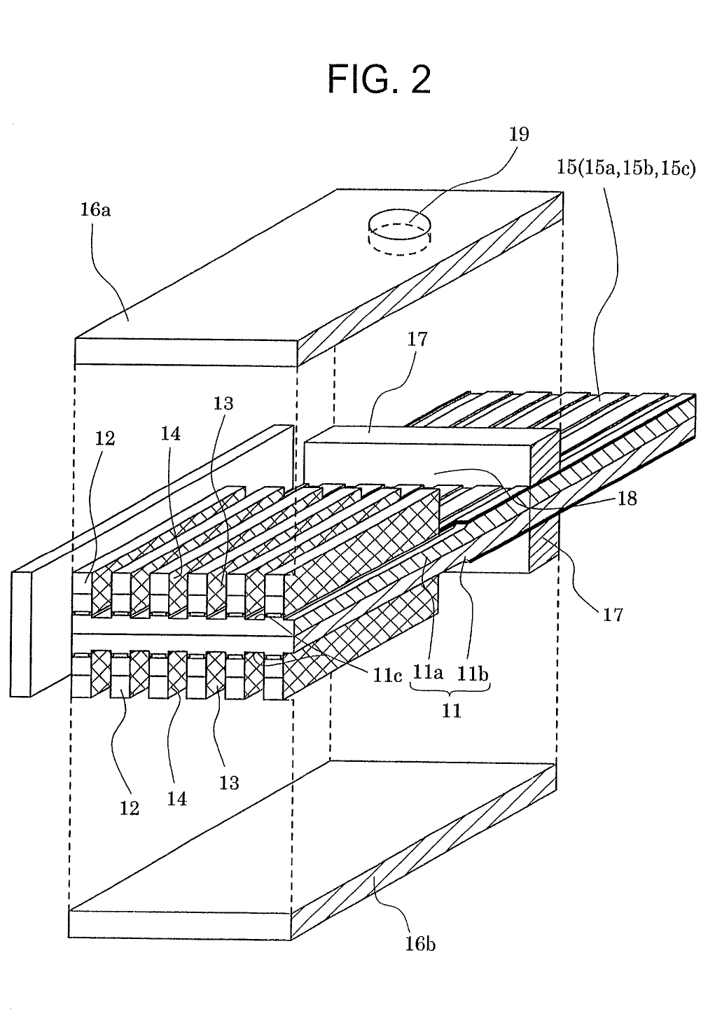

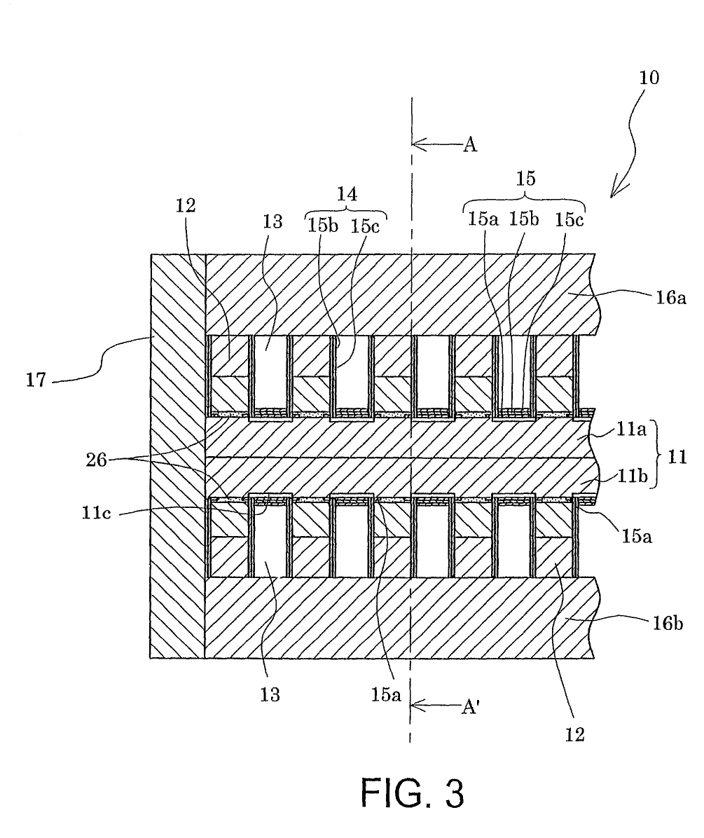

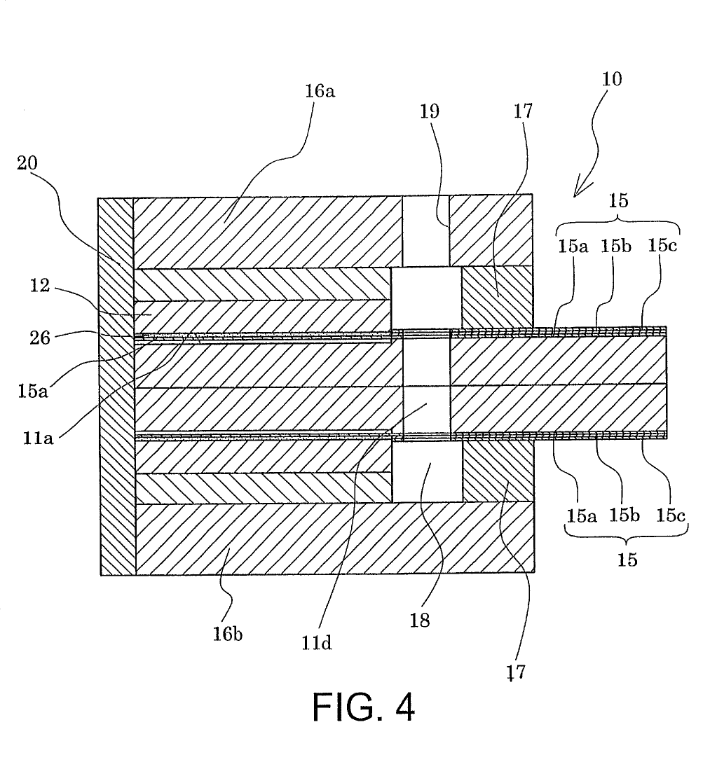

FIG. 1 is a perspective view indicating a head chip according to Embodiment 1 of the present invention. FIG. 2 is a sectional/perspective view of the head chip. FIG. 3 is a sectional view showing a chamber along a parallel-arranging direction. FIG. 4 is a sectional view taken along a line A-A′ of FIG. 3.

As shown in the figure, both surfaces of a plate-shape flow path board 11 formed of a transparent dielectric material are provided with a plurality of chambers 13 defined by partition walls 12 such that the partition walls 12 made of piezoelectric ceramic are arranged in parallel with predetermined intervals.

This flow path board 11 is formed by jointing surfaces of two flow path boards 11a and 11b made of glass, on one side of which the partition walls 12 are formed.

A piezoelectric ceramic plate is adhered by an adhesive agent 26 in accordance with respective sides of the flow path boards 11a and 11b before bonding, and the partition walls 12 are formed by cutting the piezoelectric ceramic plate using, for example, a disk-shape dice cutter. At this time, in order to cut out the piezoelectric ceramic plate completely, the surfaces of the flow path boards 11a and 11b are ground by the dice cutter, and concave portions 11c corresponding to the respective chambers 13 are formed in the flow path boards 11a and 11b. Of course, only the piezoelectric ceramic plate is completely cut out and the concave portions 11c may not be formed. Also, separate partition walls 12 may be adhered with predetermined intervals.

This piezoelectric ceramic plate is formed by jointing two piezoelectric ceramic plates, having different polarization directions, in the thickness direction. Further, electrodes 14 for applying driving electric field are formed on the entire surface of the side surfaces of the partition walls 12, which are surfaces of the respective chambers 13.

Further, on the flow path board 11, wiring lines 15 are provided on the inner sides of end portions of the respective partition walls 12 in the longitudinal direction. The wiring line 15 has an inorganic conductive film 15a as the lowermost layer.

A transparent conductive film may be given, for example, as the inorganic conductive film 15a. As the transparent conductive film, ITO (oxide of indium and tin), SnO₂, ZnO, ATO (oxide of antimony and tin) or the like may be given. In this embodiment, ITO is used as the inorganic conductive film 15a. As to the wiring line 15, at least one layer of metal film formed by selective electroless plating is formed on the inorganic conductive film 15a, and in this embodiment, two layers of a nickel metal film 15b and a gold metal film 15c are adopted.

In addition, although the electrode 14 is not particularly limited, it is formed of the nickel metal film 15b and the gold metal film 15c, which are formed together with the wiring 15 on the side surface of the partition wall 12 by the selective electroless plating.

Here, the inorganic conductive film 15a is elongated along the chambers 13 defined on both sides between the flow path board 11 and the respective partitions 12, and the end portion of the inorganic conductive film 15a in the width direction is firmly in contact with the electrode 14. Thus, electrical conduction between the electrode 14 and the wiring line 15 is realized.

It should be noted that, although the inorganic conducive film 15a, that is elongated between the flowpath board 11 and the partition wall 12, is provided along the longitudinal direction of the partition wall 12, the present invention is not limited to this provided that the inorganic conductive film 15a is electrically conducted to the electrode 14 provided on the side surface of the partition wall 12. The inorganic conductive film 15a may be elongated to only one end of the electrode 14 in the longitudinal direction. Alternatively, the inorganic conductive film 15a may not be elongated between the flow path board 11 and the partition wall 12, and may be provided so as to be in contact with the end surface of the partition wall 12. In any case, it is only necessary that the electrode 14 is firmly conducted to the wiring line 15.

Further, guide walls 17 made of plastic, for example, are adhered to both side surfaces of the flow path board 11 and the inner portions of the flowpath boards 11a and 11b at the end portions of the respective partition walls 12 in the longitudinal direction on the respective flow path boards 11a and 11b by an adhesive agent or the like. Then, ink chambers 18 that communicate with the respective chambers 13 are defined by the guide walls 17 and the partition walls 12 on each of the flow path boards 11a and 11b. It should be noted that the ink chambers 18 defined on the flow path boards 11a and 11b are communicated with the regions opposite to the ink chambers 18 of the flow path boards 11a and 11b via ink communication holes lid formed therethrough.

Cover plates 16a and 16b made of glass having plate shape are jointed onto the partition walls 12 and the guide walls 17 formed on the flow path boards 11a and 11b, respectively, and the chambers 13 and the ink chambers 18 are sealed. Further, the cover plate 16a is provided with an ink supply port 19, which supplies ink to the ink chamber 18 defined on the flow path board 11a and is bored through the,cover plate 16a in the thickness direction.

It should be noted that the ink supply port 19 of the cover plate 16a is formed by sandblasting in this embodiment.

Here in this embodiment, the chambers 13 are divided into groups corresponding to respective colors consisting of black (B), yellow (Y), magenta (M), and cyan (C), and four ink chambers 18 and four ink supply ports 19 are provided, respectively.

Further, one piece of nozzle plate 20 is jointed to the uniform entire surface of the end surfaces of the partition walls 12 and the end surface of the flow path board 11, and nozzle openings 21 are pierced in the nozzle plate 20 at the positions opposite to the respective chambers 13.

This nozzle plate 20 may be formed by, for example, plate-shaped metal, plastic, glass, or polyimide film. Further, although not shown in the figure, a water repelling film having a water repelling property is provided to the surface of the nozzle plate 20 opposing a subject to be printed, in order to prevent adhesion of ink or the like.

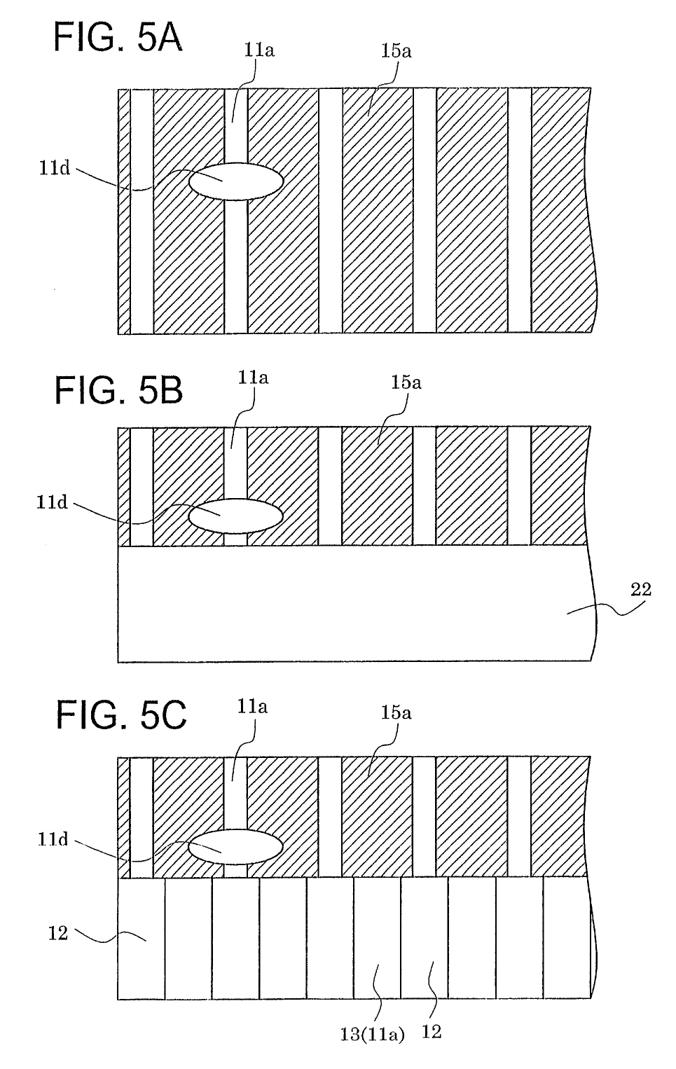

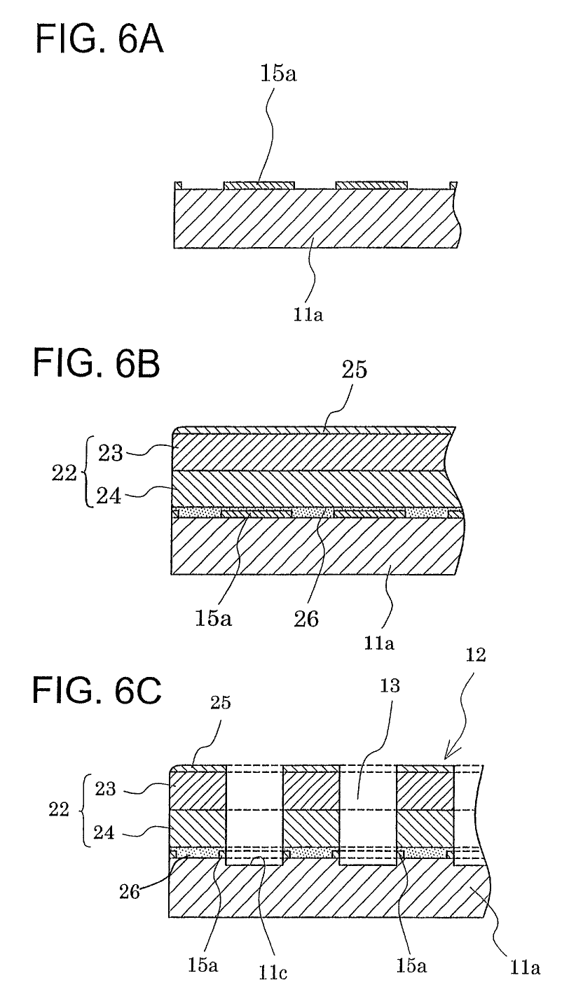

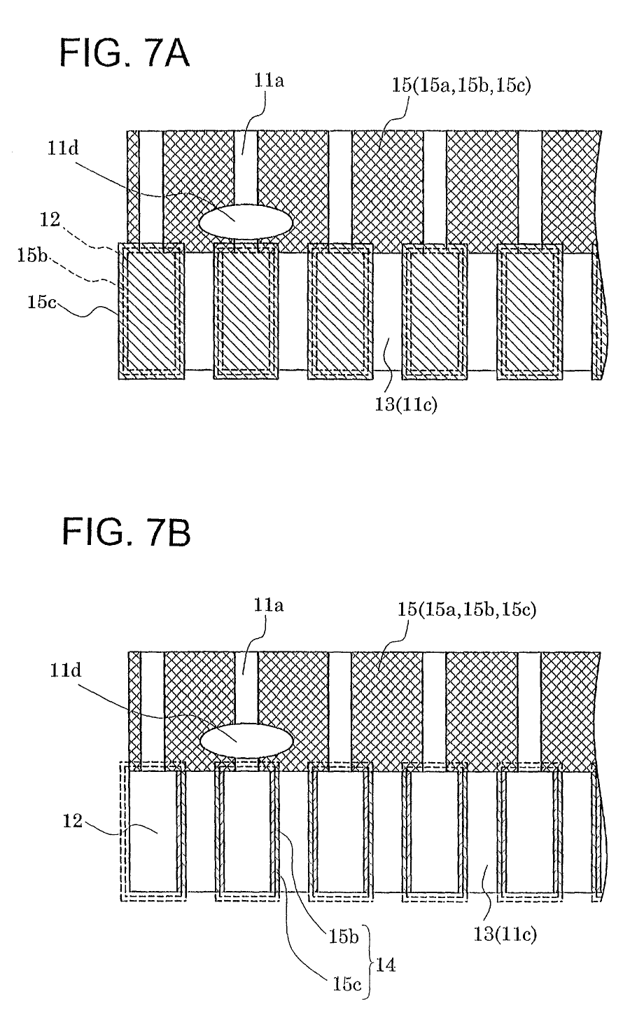

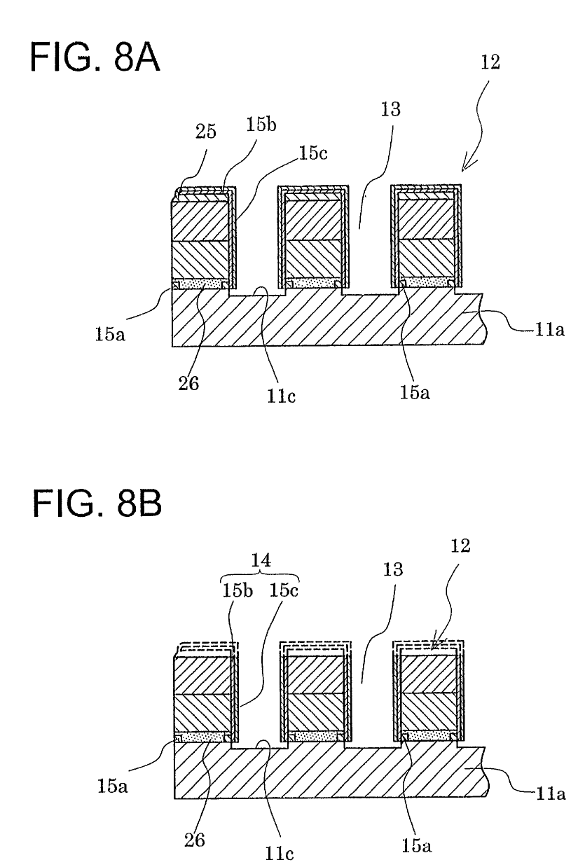

Here, an example of a manufacturing method of a head chip in accordance with the above embodiment will be explained in detail. It should be noted that FIG. 5 and FIG. 7 are top views showing manufacturing steps for forming the partition walls and the wiring lines on the flow path board 11a of the head chip. FIG. 6 and FIG. 8 are cross sectional views of the chamber 13 along the parallel-arranging direction, which correspond to the manufacturing steps of FIG. 5 and FIG. 7, respectively.

First, as shown in FIG. 5A and FIG. 6A, an ITO film that is the inorganic conductive film 15a is formed on the flow path board 11a in which the ink communication hole lid is pierced in advance, and the ITO film is patterned with a predetermined shape, here with an interval that is slightly wider than that of the chamber 13.

There is no limitation on the forming method of the inorganic conductive film 15a. For example, after the inorganic conductive film 15a is formed by a sputtering method, application method or the like, it may be patterned with photolithography or the like.

Next, as shown in FIG. 5B and FIG. 6B, a piezoelectric ceramic plate 22 in which surfaces other than a bonding surface are coated with a resist 25 is adhered onto the inorganic conductive film 15a by the adhesive agent 26. This piezoelectric ceramic plate 22 is formed by jointing two sheets of piezoelectric ceramic plates 23 and 24 having different polarization directions in the thickness direction, the surfaces other than the bonding surface are coated with the resist 25, and then the piezoelectric ceramic plate 22 is adhered to the flow path board 11 by the adhesive agent 26. It should be noted that the resist 25 may be provided after the piezoelectric ceramic plate 22 is adhered to the flow path board 11.

Thereafter, as shown in FIG. 5C and FIG. 6C, the piezoelectric ceramic plate 22 is cut out to form the partition walls 12 and chambers 13. In this embodiment, for example, the piezoelectric ceramic plate 22 is cut out in the thickness direction with the width that is narrower by a predetermined width than the width of the inorganic conductive film 15a by using the disk-shape dice cutter to thereby form the partition walls 12 and chambers 13.

At this time, the inorganic conductive film 15a is cut out to the surface of the flow path board 11a in order that the inorganic conductive film 15a provided on the flow path board 11a is not electrically conducted within the chambers 13. Thus, concave portions 11c are formed. Of course, the inorganic conductive film 15a may be previously patterned into the cut-out condition.

Further, when the partition walls 12 are formed, since the piezoelectric ceramic plate 22 is cut out with the width that is narrower by a predetermined width than the width of the inorganic conductive film 15a, the inorganic conductive film 15a remains between both the end portions of the partition walls 12 in the width direction and the flow path board 11 along the longitudinal direction, and the side surfaces are exposed. Then, the inorganic conductive films 15a formed on both sides of the respective chambers 13 are continuous with the inorganic conductive films 15a that become the wiring lines 15 at the rear of the partition walls 12 as shown in FIG. 6C.

Next, as shown in FIG. 7A and FIG. 8A, a starting catalyst containing palladium, platinum or the like is absorbed over the entire surfaces of both the partition walls 12 and the inorganic conductive films 15a, namely surfaces other than the surface of the flow path board 11a. Thereafter, the nickel metal film 15b and the gold metal film 15c are formed by selective electroless plating.

The wiring line 15 of three layers that is constituted of the inorganic conductive film 15a, the nickel metal film 15b and the gold metal film 15c is formed by this selective electroless plating, and the two layers of the nickel metal film 15b and the gold metal film 15c are formed over the entire surface of the partition wall 12. Further, the metal films 15b and 15c provided over the entire surface of the partition wall 12 are electrically conducted to the inorganic conductive film 15a provided between the partition wall 12 and the flow path board 11a at the exposed side surface.

Next, as shown in FIG. 7B and FIG. 8B, the resist 25, which is formed on both the upper surface of the partition wall 12 and the end surfaces of the partition wall 12 along the longitudinal direction, and also the unnecessary metal films 15b and 15c formed on the resist 25 are lifted off. As a result, such an electrode 14, which is not short-circuited on both the side surfaces of the partition wall 12 and which is constructed of two layers made of the nickel metal film 15b and the gold metal film 15c, is formed.

As previously explained, both the electrode films 15b and 15c which constitute the electrode 14 formed in this manner are electrically conducted with the inorganic conductive film 15a on the exposed side surfaces thereof. In other words, the electrode 14 is mutually and electrically conducted via the inorganic conductive film 15a to the wiring line 15.

Thereafter, the partition walls 12 and the wiring lines 15 are also formed on the flow path board 11b by the above-mentioned steps. As shown in FIG. 1 to FIG. 4, the surfaces of the flow path boards 11a and 11b, in which the partition walls 12 and the wiring lines 15 are formed on the other surfaces thereof, are jointed to each other by the adhesive agent such that the end surfaces in which the partition walls 12 are formed, are made flush with each other.

At this time, since the flow path boards 11a and 11b are formed of a transparent dielectric material, and formed of glass in this embodiment, alignment of the chambers 13 arranged in parallel on the flow path boards 11a and 11b can be performed visually with ease from the surfaces of the flow path boards 11a and 11b in comparison with the end surfaces of the flow path boards 11a and 11b. Therefore, the positions of the chambers 13 are not shifted, and the assembly can be performed with high precision.

Thereafter, the guide walls 17 made of plastic are adhered to both the end surfaces of the partition walls 12 of the flow path board 11 in the parallel-arranging direction and at the rear of the partition walls 12 by the adhesive agent or the like to define the ink chambers 18 on the flow path boards 11a and 11b. Then, the cover plates 16a and 16b are adhered onto the partition walls 12 by the adhesive agent or the like so as to sandwich the flow path board 11 on which the partition walls 12 are formed. Also, the plate-shape nozzle plate 20 in which the nozzle openings 21 are pierced with respect to each of the chambers 13 is adhered to the end surface of the flow path board 11 at the side on which the partition walls 12 are provided by the adhesive agent or the like. Then, the outer shape of the resultant head chip is processed by dicing, and thus, a head chip 10 is manufactured.

As explained above, in this embodiment, the partition walls 12 are formed on the flow path boards 11a and 11b, respectively, and the flow path boards 11a and 11b are visually jointed together. Thus, the positions of the chambers 13 can be easily aligned without fail.

The head chip formed as described above may be provided with twice as many nozzle openings 21 as compared with the head chip in which chambers are formed on only one surface. Therefore, the recording density can be improved.

In addition, the manufacturing cost can be reduced by using a large amount of low-cost glass.

Furthermore, driving principle etc. of the head chip 10 are as described in the prior art, and therefore, the description thereof is omitted here.

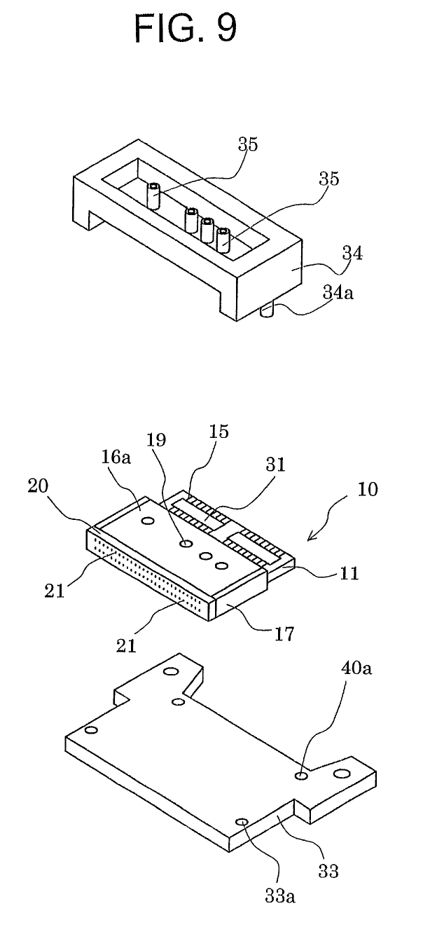

FIG. 9 is an exploded perspective view indicating a head chip unit on which the above-explained head chip 10 is mounted.

As illustrated in FIG. 9, a driver circuit 31 such as an integrated circuit for driving the head chip 10 is directly connected to the wiring line 15, and this driver circuit 31 is mounted on the glass board 11 of the head chip 10. Also, a basis plate 33 made of aluminum is assembled on the side of the glass board 11, and a head cover 34 is assembled on the side of the cover plate 16 in the head chip 10. The base plate 33 is fixed to the head cover 34 such that an engaging shaft 34a of the head cover 34 is engaged with an engaging hole 33a of the base plate 33, and the head chip 10 is sandwiched by both the base plate 33 and the head cover 34. An ink conducting path 35 is formed on the head cover 34, and this ink conducting path 35 is communicated with each of the ink supply ports 19 of the cover plate 16.

Also, such a head chip unit 40 may be assembled with, for example, a tank holder, which detachably holds an ink cartridge, to be used.

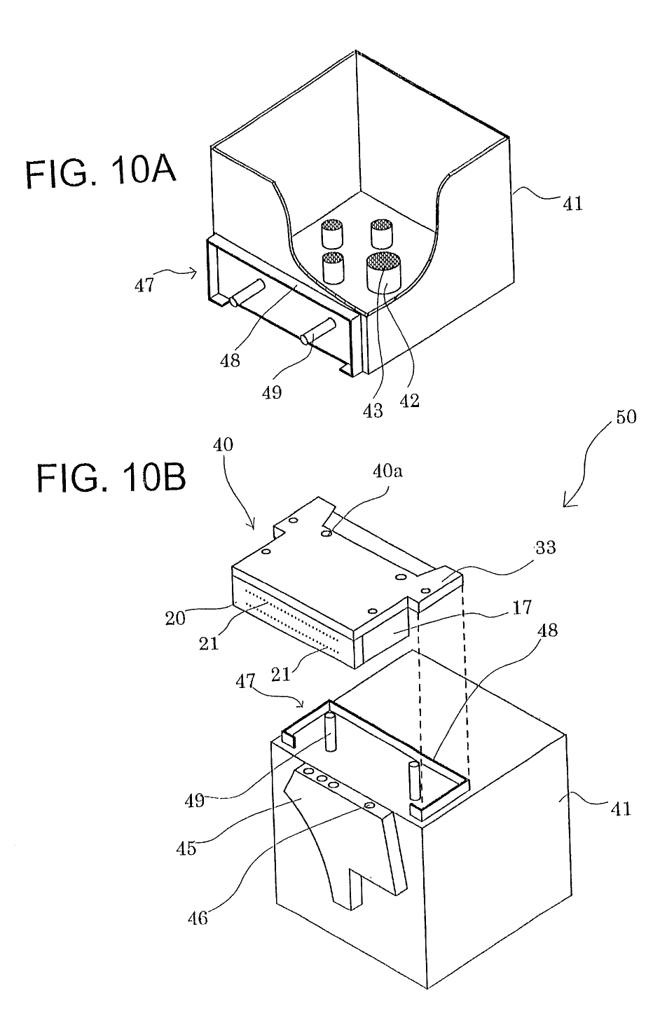

FIG. 10A shows an example of such a tank holder. FIG. 10B shows the tank holder 41 and the head chip unit 40 which is assembled with the tank holder 41. The tank holder 41 shown in FIG. 10 is formed to have substantially a box shape whose one surface is opened, and an ink cartridge (not shown) may be detachably held. A coupling portion 42 is provided on an upper surface of a bottom wall, and is coupled to the ink supply port 19 corresponding to an opening portion formed in the bottom portion of the ink cartridge. A plurality of the coupling portions 42 are provided with respect to each of color ink, for instance, black (B) ink, yellow (Y) ink, magenta (M) ink, and cyan (C) ink. An ink flow path (not shown) is formed inside the coupling portion 42, and a filter 43 is provided at a tip portion of the coupling portion 42 which constitutes an opening of this ink flow path. The ink flow path formed inside the coupling portion 42 is communicated to the rear surface of the bottom wall. The respective ink flow paths are communicated to a head coupling port 46 which is opened in the partition wall of a flow path board 45 via an ink flow path (not shown) which is provided within the flow path board 45 provided on the side of the rear surface of the tank holder 41. This head coupling port 46 is opened on the side of the side surface of the tank holder 41, and a head chip unit holding portion 47 which holds the above-described head chip unit 40 is provided on the bottom portion of this partition wall. In the head chip unit holding portion 47, there are provided a surrounding wall 48 and an engaging shaft 49. The surrounding wall 48 surrounds the driver circuit 31 provided on the glass board 11, and is formed into substantially a U-shape and positioned in an upright manner. The engaging shaft 49 is engaged with an engaging hole 40a formed in the base plate 33 of the head chip unit 40 provided inside the surrounding wall 48.

As a consequence, the head chip unit 40 is mounted on this head chip unit holding portion 47, so that a head unit 50 can be completed. At this time, the ink conducting path 35 formed in the head cover 34 is coupled to the head coupling port 46 of the ink board 45. As a result, the ink which is conducted from the ink cartridge via the coupling portion 42 of the tank holder 41 is conducted via the ink flow path formed in the ink board 45 into the ink conducting path 35 of the head chip unit 40, so that this ink is filled into both the ink chambers 18 and the chambers 13.

Second Embodiment

In Embodiment 1 described above, the partition walls 12 are provided on the flow path boards 11a and 11b, respectively, and the flow path boards 11a and 11b are jointed to each other. Embodiment 2 is the same as Embodiment 1 described above other than the point that the partition walls 12 are arranged in parallel on both the surfaces of the flow path board 11a.

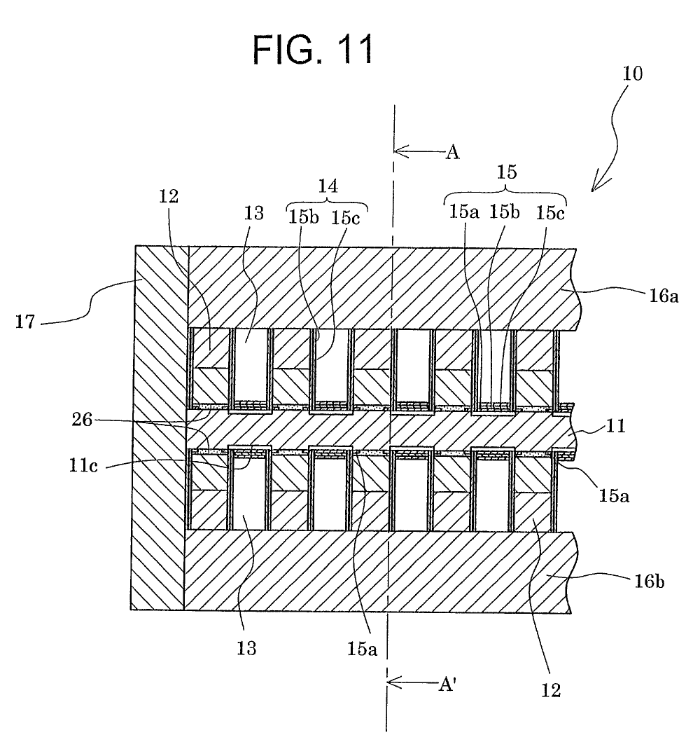

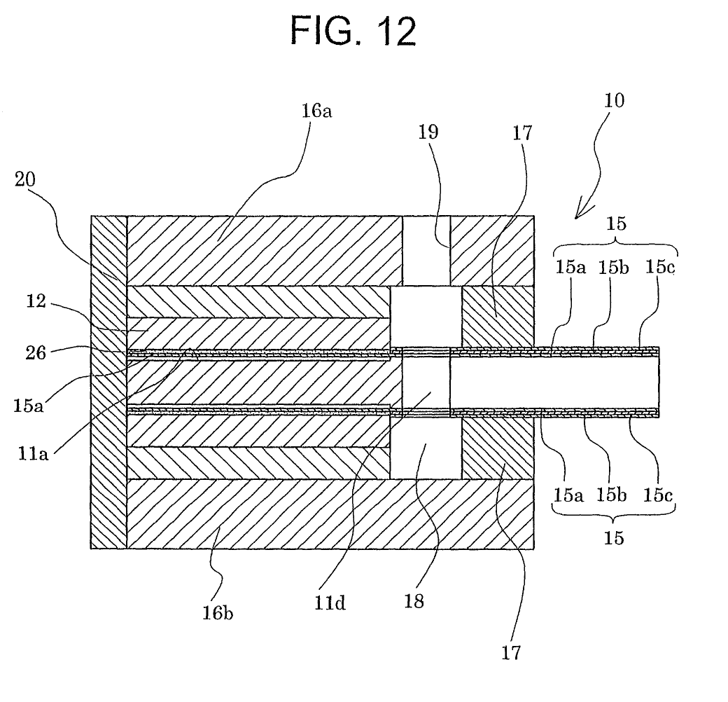

FIG. 11 is a cross sectional view of chambers of a head chip in accordance with Embodiment 2 along the parallel-arranging direction. FIG. 12 is a cross sectional view taken along the line A-A′ of FIG. 11.

As shown in the figure, in the head chip of Embodiment 2, the partition walls 12 are arranged in parallel on both surfaces of the flow path board 11 with predetermined intervals.

The partition walls 12 are formed by, for example, cutting a piezoelectric ceramic plate, and are respectively adhered to the flow path board 11 by the adhesive agent 26 so as to be aligned to one side of the flow path board 11 with the predetermined intervals.

It should be noted that the forming method of the partition walls 12 is not limited to this. For example, the piezoelectric ceramic plate may be adhered to both the surfaces of the flow path board 11 by the adhesive agent 26, and then cut using a wire saw.

In any case, when the partition walls 12 are provided on both the surfaces of the flow path board 11, which is a transparent dielectric material, since the flow path board 11 is transparent, the positions of the partition walls 12 on both the surfaces can be visually confirmed with ease.

Other Embodiment

The head chip according to the present invention is explained as described above. However, the present invention is not limited to Embodiments 1 and 2 described above.

For example, in Embodiments 1 and 2 described above, the flow path board 11 is made of glass. However, there is no limitation on the material for the flow path board provided that one surface of the flow path board may be visually confirmed from the other surface.

Further, in Embodiments 1 and 2, the metal films 15b and 15c by selective electroless plating are used as a part of the wiring line 15 and the electrode 14. However, there is no limitation on this. For example, as to the wiring line, a wiring board on which wiring patterns are formed in advance may be adhered onto the flow path board, and as to the electrode, the metal films may be formed by a known vapor deposition in an oblique direction.

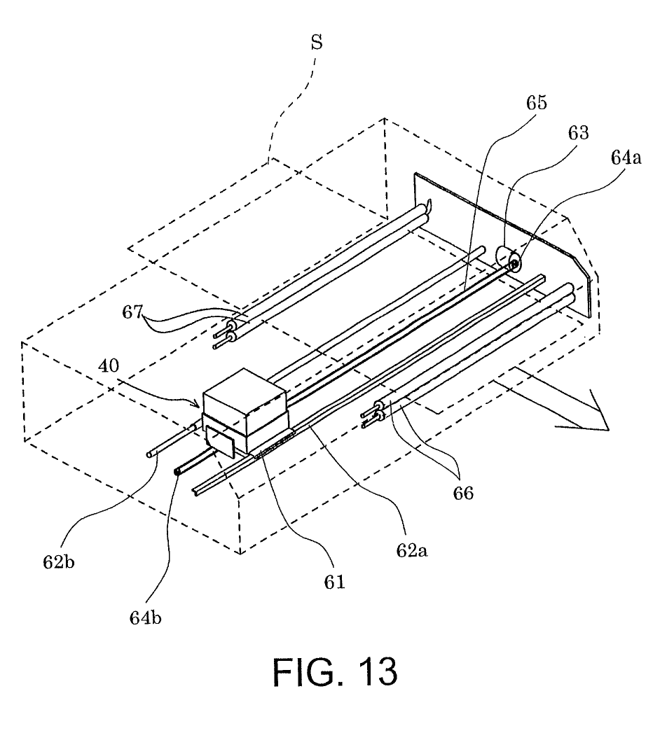

Such a head unit 50 is mounted on, for example, a carriage of an ink-jet type recording apparatus so as to be used. FIG. 13 schematically shows an example of this use mode of-the head unit 50.

As shown in FIG. 13, a carriage 61 is movably mounted on one pair of guide rails 62a and 62b along a shaft direction. This carriage 61 is transported by way of a timing belt 65 which is suspended between a pulley 64a, that is provided on one end side of the guide rail 62, and is coupled to a carriage driving motor 63, and another pulley 64b that is provided on the other side of this guide rail 62. A pair of transfer rollers 66 and 67 are provided along the guide rails 62a and 62b on both sides in a direction perpendicular to the transport direction of the carriage 61. These transfer rollers 66 and 67 are used to transport a recording medium “S” located below the carriage 61 along a direction perpendicular to the transport direction of this carriage 61.

The above-explained head unit 50 is mounted on the carriage 61, and the above-explained ink cartridge may be detachably mounted on this head unit 50.

In accordance with such an ink-jet type recording apparatus, while the recording medium “S” is fed, the carriage 61 is scanned along the direction perpendicular to this medium feeding direction, so that both a character and an image can be recorded on this recording medium “S” by the head chip.

While the present invention has been described with the embodiment, the present invention is not limited to the construction described above.

As explained above, in the present invention, the chambers are arranged in parallel on the board having a light transmitting property with the predetermined intervals, and a plurality of the boards are laminated in the vertical direction. Therefore, the alignment of the chambers can be easily performed with high precision, and the head having high density can be formed.

What is claimed is:

1. A head chip in which: partition walls made of piezoelectric ceramic are arranged on a board with predetermined intervals; chambers are defined between the respective partition walls; a driver voltage is applied to electrodes provided on the side surfaces of the partition walls to change the capacity in the chambers; and the ink filled in the chambers is jetted from nozzle openings,
characterized in that the chambers are arranged between two upper and lower sheets of boards, which are made of a dielectric material having a light transmitting property, in the width direction with predetermined intervals, and also a plurality of the boards are laminated in the vertical direction.

2. A head chip as claimed in claim 1, characterized in that a plurality of units, in which the partition walls are arranged between two boards with predetermined intervals, are laminated.

3. A head chip as claimed in claim 1, characterized in that the partition walls are arranged on both surfaces of a board with predetermined intervals.

4. A head chip as claimed in claims 1, characterized in that:
a nozzle plate having the nozzle openings that communicate with the chambers is provided at end surfaces of the partition walls in the longitudinal direction; and
ink chambers that communicate with the respective chambers, are provided on the side of the other end portions of the partition walls.

5. A head chip as claimed in claim 4, characterized in that the nozzle plate is formed of a dielectric material.

6. A head unit characterized in that the head unit comprises the head chip as claimed in any one of claims 1 to 5 and a head holder that,mounts the head chip.

7. A head unit as claimed in claim 6, characterized in that the head holder may detachably hold an ink cartridge in which ink is stored.
